(19) United States
(12) Patent Application Publication
(10) Pub. No.: US 2026/0058078 A1
(43) Pub. Date: Feb. 26, 2026

(54) MULTIPLEX SWITCH PANEL ASSEMBLY AND A METHOD OF INSTALLING THE SAME

(71) Applicant: Spyder Controls Corp., Lacombe (CA)

(72) Inventors: Theodore Shaw, Lacombe (CA); Curtis Letniak, Lacombe (CA)

(73) Assignee: Spyder Controls Corp., Lacombe, AB (CA)

(21) Appl. No.: 19/298,912

(22) Filed: Aug. 13, 2025

Related U.S. Application Data
(60) Provisional application No. 63/686,621, filed on Aug. 23, 2024.

(51) Int. Cl. H01H 13/70; H01H 13/04; H01H 13/14

(52) U.S. Cl. CPC H01H 13/70; H01H 13/04; H01H 13/14

(57) ABSTRACT

The present invention discloses a multiplex switch panel assembly and a method of installing the same. The multiplex switch panel assembly includes a plurality of front panel mounts and pushbutton switches. A printed circuit board (PCB) electrically connected to the plurality of front panel mounts pushbutton switches. A set of split mounting rings for each switch, configured to be installed around a respective switch on a front side of a panel after the assembly is inserted from a rear side of the panel, thereby preventing the switches from passing back through holes in the panel. A set of tensioning devices configured to secure the multiplex switch panel assembly in place from the rear side of the panel.

### CROSS-REFERENCE TO RELATED APPLICATIONS

The present application claims the benefit of copending U.S. Provisional Patent Application Ser. No. 63/686,621, filed Aug. 23, 2024, which is presently pending and are incorporated herein by reference in its entirety.

### TECHNICAL FIELD

The present invention relates generally to the field of electrical control systems, and more particularly to multiplex switch panel assemblies that support rear panel mounting, customizable switch interfaces, waterproofing, and digital communication, as well as methods for installing the same.

### BACKGROUND

Electrical control systems are integral components in various industries, particularly in automotive, marine, and recreational vehicles. These systems often utilize multiple pushbutton switches mounted on panels for controlling various functions. One common switch type used in such applications is the anti-vandal pushbutton switch, valued for its durability, compactness, and visual appeal.

The conventional approach involves front panel mounting, where each switch is individually installed and wired, posing significant challenges in terms of installation time, complexity, and aesthetic consistency.

Traditionally, these switches are mounted from the front side of the panel, requiring each switch to be individually inserted and secured, usually with locking nuts, and then manually wired from the rear. This process becomes increasingly cumbersome and time-consuming as the number of switches increases, such as in the dashboard assembly of a boat. The individual installation and wiring of each switch not only increase labor costs but also complicate the assembly process. Moreover, maintaining a uniform and aesthetically pleasing appearance on the front panel while ensuring functional integrity is a persistent challenge.

Existing multiplex switch panels attempt to address some of these challenges by integrating multiple switches into a single assembly. These panels are designed for front mounting and typically feature fasteners, such as mounting nuts, visible on the front side of the panel. While these solutions can reduce wiring complexity by consolidating connections, they fall short in providing a seamless, aesthetic look that front panel mount switches offer. Others use rear-mounting techniques but lack features such as indicator lighting, sufficient panel thickness adaptability, or the visual/tactile consistency associated with individual anti-vandal switches. Additionally, conventional rear-mount solutions often fail to accommodate switch sizes of 15 mm or larger with backlighting, limiting their use in demanding or stylistically sensitive applications.

From testing and experience, it has been observed that a well-sealed switch assembly can maintain tactile feel if a sufficient shared air cavity is provided behind the switches. However, creating such a cavity while keeping manufacturing simple and reliable presents a technical challenge. Moreover, the introduction of potting compounds for waterproofing can risk compromising the cavity unless proper containment measures, such as using the PCB itself as a sealing barrier, are taken.

There also remains a need for aesthetically pleasing and installation-friendly retention mechanisms. Existing fasteners often protrude or are difficult to align uniformly. Standard split rings are typically flat or symmetrical and do not offer sufficient tolerance compensation or moldability for mass production.

Further, many conventional systems lack digital programmability, CAN bus integration, RGB indicator lighting, and user-configurable button behavior (e.g., tap, hold, double-press). Such features are increasingly demanded in modern vehicles and control systems for enhanced feedback, customization, and reduced wiring complexity.

Accordingly, there is a need for a multiplex switch panel assembly and an associated method of installation that allows for clean rear mounting using front panel mount anti-vandal switches; enables seamless front appearance through novel split ring retention mechanisms; provides robust waterproofing while maintaining tactile response via a shared air cavity sealed by the PCB; uses injection-moldable materials optimized for UV and environmental resistance; and supports digital features including RGB lighting, programmable behavior, and simplified single-connector communication.

### Objectives of the Invention

It is an object of the present invention to provide a multiplex switch panel assembly that enables rear mounting of multiple anti-vandal style pushbutton switches while preserving the aesthetic and tactile characteristics typically associated with front-mounted installations.

It is another object of the invention to provide a rear-mount retention mechanism using split mounting rings installed from the front side of the panel and a corresponding set of rear-side tensioning devices, such as screws, springs, wedges, or ramped rings, to securely compress and hold the switch assembly in place, regardless of panel thickness.

It is another object of the invention to achieve a seamless and visually clean front panel appearance by eliminating the need for visible front-facing fasteners or bezels, while accommodating 15 mm or larger illuminated switches in a modular, preassembled panel format.

It is another object of the invention to provide a waterproof switch assembly that maintains reliable tactile switch response without venting, by using a shared internal air cavity behind the switches and employing the printed circuit board (PCB) as a barrier to contain potting compound, thereby eliminating the need for additional sealing materials around the PCB.

It is another object of the invention to utilize high-performance polymer materials, such as ASA or ASA-blend plastics, for structural components like the housing and split rings to ensure UV resistance, impact durability, adhesion to potting compounds, and compatibility with injection molding.

It is another object of the invention to implement a uniquely shaped helical split ring with an angled gap, allowing for improved tolerance handling, simplified molding, and minimal visual disruption on the panel front when installed and compressed.

It is another object of the invention to provide a customizable center cap for each switch, wherein a clear or translucent cap is coated with an opaque layer, which is selectively removed via laser engraving to form symbols or text, and features dual orientation notches for vertical or horizontal installation flexibility.

It is another object of the invention to enable programmability and digital control of each switch in the assembly, allowing independent behavior profiles (e.g., press, hold, double-tap) and individually adjustable RGB backlighting, with communication and power managed via a single CAN bus connection to reduce wiring complexity and improve installation efficiency.

It is yet another object of the invention to provide an installation method for the switch panel assembly that is efficient, repeatable, and compatible with panels of varying thickness and material types, allowing for robust and professional installation in field, factory, or service environments.

### SUMMARY OF THE INVENTION

According to a first aspect of the present invention, a switch panel assembly configured for rear panel mounting is provided. The switch panel assembly comprising: a panel having a front side and a rear side; a plurality of anti-vandal pushbutton switches, each configured to extend through a corresponding hole in the panel from the rear side to the front side; a plurality of split mounting rings, each configured to be positioned around a respective pushbutton switch on the front side of the panel to prevent the switch from passing back through the corresponding hole; and a tensioning mechanism disposed on the rear side of the panel, the tensioning mechanism being configured to apply axial pressure to the pushbutton switches, thereby compressing the split mounting rings against the front side of the panel and securing the switches in position.

In one embodiment of the invention, the tensioning mechanism comprises one or more of: screws, springs, wedges, ramped rings, or shims.

In one embodiment of the invention, each of the split mounting rings has a helical shape and an angled split, configured to reduce visible gaps and enable compression during mounting.

In one embodiment of the invention, the split mounting rings are dimensioned to accommodate variations in size and shape among the plurality of anti-vandal pushbutton switches.

In one embodiment of the invention, the switch panel assembly further comprising: indicator lights integrated into each pushbutton switch, wherein lighting features are programmable.

In one embodiment of the invention, the indicator lights are RGB LEDs, and the lighting system includes independent brightness control for each color channel to allow visual customization.

In one embodiment of the invention, the switch panel assembly further comprising a printed circuit board (PCB) positioned behind the pushbutton switches, wherein the PCB is electrically connected to each switch.

In one embodiment of the invention, the PCB is configured to communicate via a connector that provides both power and digital communication signals.

In one embodiment of the invention, each pushbutton switch comprises integrated RGB lighting, and the PCB is configured to independently control the brightness and color output of each switch.

In one embodiment of the invention, the PCB is programmed to facilitate digital communication for controlling switch functions and lighting behaviors.

According to a second aspect of the invention, a switch panel assembly is provided. The switch panel assembly comprising: a housing; a plurality of anti-vandal pushbutton switches sealed within the housing; a printed circuit board (PCB) mounted within the housing and electrically connected to the pushbutton switches; an internal air cavity disposed between the plurality of pushbutton switches and the PCB; and a potting compound disposed on a side of the PCB opposite the air cavity, wherein the PCB acts as a barrier to prevent ingress of the potting compound into the air cavity.

In one embodiment of the invention, the potting compound has a viscosity of at least 10,000 centipoise and a working time of less than 30 minutes.

In one embodiment of the invention, the potting compound comprises a two-part urethane formulation.

According to a third aspect of the invention, a switch panel assembly configured for rear panel mounting is provided. The switch panel assembly comprising: a panel having a front side and a rear side; a plurality of anti-vandal pushbutton switches, each configured to extend through a corresponding hole in the panel from the rear side to the front side; and a plurality of split mounting rings, each comprising: a circumferential body having a helical contour along its axis; an angled split defined between opposing ends of the circumferential body; and a front flange configured to rest against the front side of the panel to resist rearward movement of the respective switch.

In one embodiment of the invention, the split mounting ring is formed of ASA or an ASA-blend plastic.

In one embodiment of the invention, a cross-sectional profile of the circumferential body of the split mounting ring is tapered or stepped to accommodate tolerance variations between the pushbutton switch and the panel opening.

In one embodiment of the invention, the switch panel assembly further comprising a customizable center cap for at least one of the anti-vandal pushbutton switches, the center cap comprising: a transparent or translucent base layer; an opaque coating disposed on a front face of the base layer; a selectively removed portion of the opaque coating forming a text or symbol by laser engraving; and two indexing features disposed 90 degrees apart on the center cap, the indexing features being configured to engage corresponding features on the pushbutton switch to permit either vertical or horizontal installation.

In one embodiment of the invention, the base layer of the center cap is formed from polycarbonate or acrylic.

### BRIEF DESCRIPTION OF THE DRAWINGS

The drawings are of illustrative embodiments. They do not illustrate all embodiments. Other embodiments may be used in addition to or instead of. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a perspective view of a panel configured to receive a multiplex switch panel assembly, in accordance with an embodiment of the present invention.

FIG. 2 illustrates a side view of a fully installed multiplex switch panel assembly mounted on the panel, showing the front panel mount pushbutton switched and rear-side tensioning components, in accordance with an embodiment of the present invention.

FIG. 3 illustrates a side view of the multiplex switch panel assembly during installation, with the switches inserted from the rear side of the panel, in accordance with an embodiment of the present invention.

FIG. 4 illustrates another side view of the multiplex switch panel assembly, depicting the attachment of split mounting rings around each switch on the front side of the panel, in accordance with an embodiment of the present invention.

FIG. 5 illustrates another side view of the multiplex switch panel assembly, highlighting the use of a screwdriver to apply tension via rear-side fasteners or screws, in accordance with an embodiment of the present invention.

FIG. 6 illustrates a side view of the completed assembly in its secured and installed state on the panel, showing the flush alignment of the switches, in accordance with an embodiment of the present invention.

FIG. 7 illustrates a front perspective view of the multiplex switch panel assembly, showing the anti-vandal switches with integrated indicator lighting and the seamless panel appearance, in accordance with an embodiment of the present invention.

FIG. 8 illustrates a side view of the switch panel assembly with an integrated printed circuit board (PCB), showing the electrical connections between the switches and the PCB, and the rear-side cable interface, in accordance with an embodiment of the present invention.

FIG. 9 illustrates a flowchart of a method for installing the multiplex switch panel assembly, including insertion from the rear, front-side ring placement, and rear-side tensioning, in accordance with an embodiment of the present invention.

FIG. 10 illustrates a cross-sectional view of a switch assembly showing a waterproofing structure with an internal air cavity beneath a printed circuit board (PCB) and a potting compound disposed above the PCB.

FIG. 11 illustrates a perspective view of a helical split mounting ring with an angled split, configured to retain a front panel mount switch on the front side of a panel.

FIG. 12 illustrates a side cross-sectional view of the split mounting ring, showing a flanged front lip and a tapered body profile that engages with a panel hole and switch barrel.

FIG. 13 illustrates an exploded perspective view of a customizable center cap, showing a clear base, opaque coating, laser-engraved symbol, and dual indexing features for orientation alignment.

FIG. 14 illustrates a top view of a pushbutton switch with the customizable center cap installed, including a visible icon and alignment features for dual-orientation installation.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high level, without detail, in order to avoid unnecessarily obscuring aspects of the present teachings.

The present invention provides a multiplex switch panel assembly and an associated method of installation that overcome deficiencies in conventional switch panel systems, including front-side clutter, wiring complexity, environmental sealing challenges, and limited digital functionality.

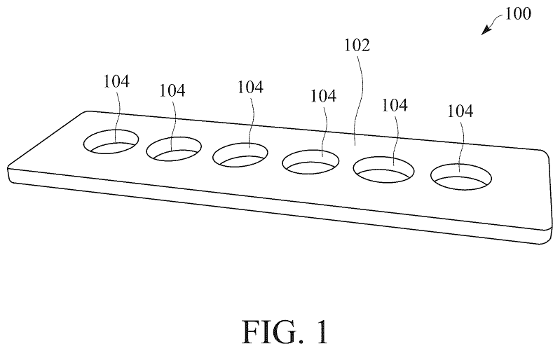

Referring now to FIG. 1, a perspective view 100 of a panel 102 is depicted in accordance with an illustrative embodiment. The panel 102 serves as a mounting surface for a multiplex switch panel assembly. The panel 102 may be made of various materials, such as, but not limited to, metal, plastic, or composite materials, depending on specific application requirements.

The perspective view 100 shows a front side of the panel 102, which is the visible surface after installation. The panel 102 has a plurality of holes 104, each designed to receive a respective front panel mount pushbutton switch (Not shown). The layout and number of the plurality of holes 104 may vary depending on the specific configuration and number of switches required for the application.

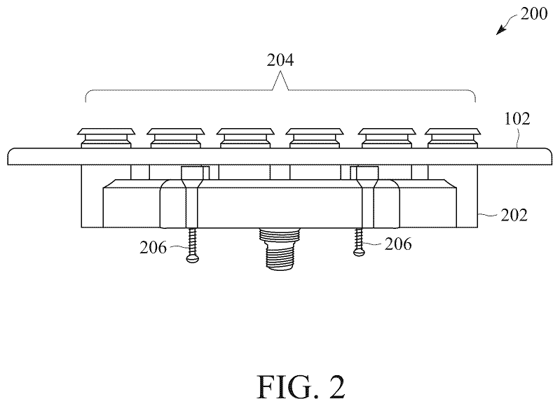

Referring now to FIG. 2, a side view 200 of a multiplex switch panel assembly 202 mounted on the panel 102 in accordance with an illustrative embodiment is depicted. FIG. 2 provides a detailed side perspective of the installation and structural components of the multiplex switch panel assembly 202, highlighting how it is secured to the panel 102.

The panel 102, shown in a cross-sectional side view, features the plurality of holes 104 through which a plurality of anti-vandal pushbutton switches 204 may be inserted. The plurality of holes 104 may be designed to correspond precisely with the locations of the anti-vandal pushbutton switch 204 in the multiplex switch panel assembly 202.

Each of the plurality of anti-vandal pushbutton switches 204 may be inserted through its corresponding hole 104 from a rear side of the panel 102, ensuring that the plurality of anti-vandal pushbutton switches 204 protrude through to the front side of the panel 102.

A set of tensioning devices 206 may be critical components that may secure the multiplex switch panel assembly 202 from the rear side of the panel 102. In this embodiment, the tensioning devices 206 can be screws, springs, wedges, ramped rings, or shims, which may be used to apply pressure and hold the multiplex switch panel assembly 202 firmly against the panel 102. This configuration allows the multiplex switch panel assembly 202 to accommodate panels of varying thicknesses without compromising the integrity or alignment of the anti-vandal pushbutton switch 204.

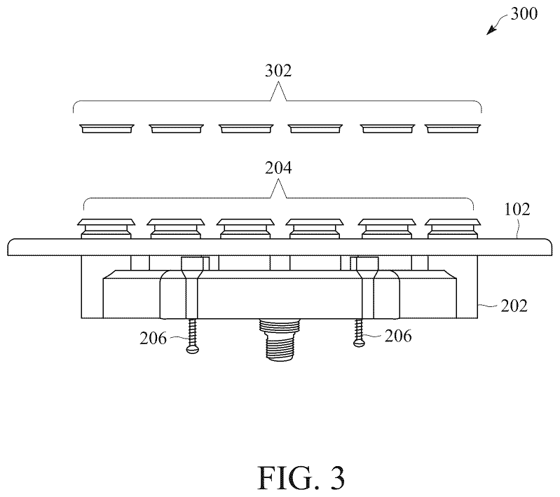

Referring now to FIG. 3 depicts a side view 300 of the multiplex switch panel assembly 202 getting installed on the panel 102 in accordance with an illustrative embodiment. Once each of the plurality of anti-vandal pushbutton switches 204 may be correctly positioned, a set of split mounting rings 302 may be installed around each of the plurality of anti-vandal pushbutton switches 204 on the front side of the panel 102. The set of split mounting rings 302 may be designed to prevent the plurality of anti-vandal pushbutton switches 204 from passing back through the plurality of holes 104, thereby securing them in place. The split design of the split mounting rings 302 may allow them to be easily placed around the plurality of anti-vandal pushbutton switches 204 after insertion.

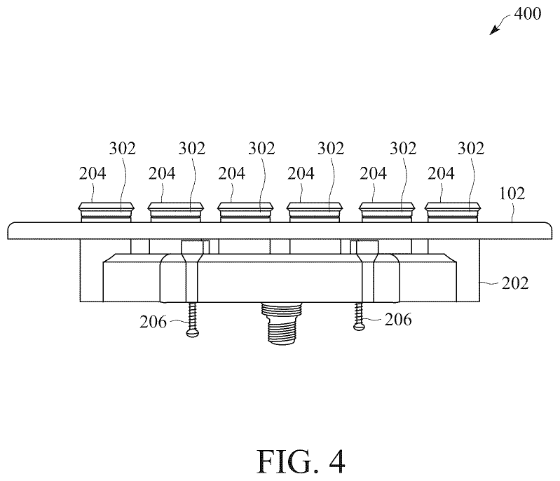

Referring now to FIG. 4, another side view 400 of the multiplex switch panel assembly 202 installed on the panel 102 in accordance with an illustrative embodiment. Following the installation of the set of split mounting rings 302, the set of tensioning devices 206 may be used to secure the multiplex switch panel assembly 202 from the rear side of the panel 102. In this embodiment, the set of tensioning devices 206 may include screws, springs, wedges, ramped rings, or shims. The set of tensioning devices 206 may apply pressure to hold the assembly firmly against the panel 102, accommodating varying panel thicknesses and ensuring a stable installation.

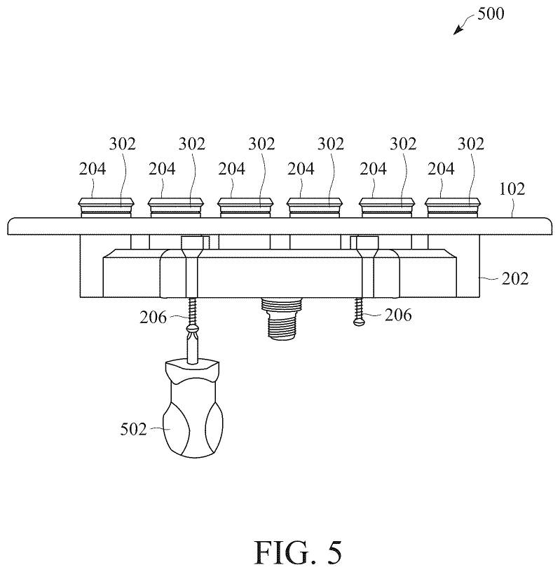

Referring now to FIG. 5 depicts another side view 500 of the multiplex switch panel assembly 202 installed on the panel 102 in accordance with an illustrative embodiment. FIG. 5 provides an enhanced visual representation of the installation process, specifically focusing on the use of a screwdriver 502 to tension the set of tensioning devices 206. In this embodiment, the set of tensioning devices 206 may include screws, which are tensioned using the screwdriver 502. The use of the screwdriver 502 to tighten the screws ensures that the assembly may be held firmly against the panel 102, accommodating varying panel thicknesses and providing a stable installation.

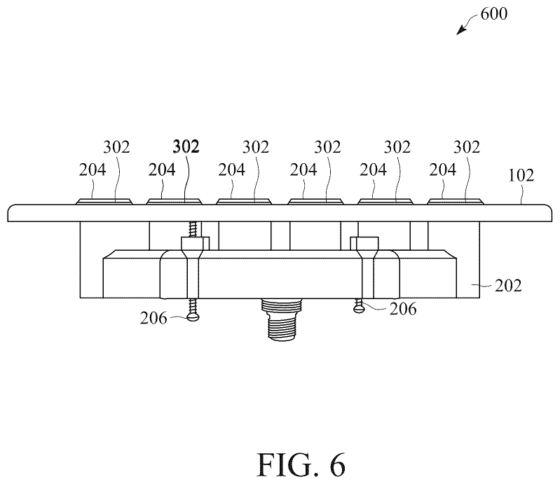

Referring now to FIG. 6 depicts another side view 600 of the multiplex switch panel assembly 202 installed on the panel 102 in accordance with an illustrative embodiment. FIG. 6 provides a comprehensive view of the fully installed multiplex switch panel assembly 202, highlighting the final arrangement and securement of its components.

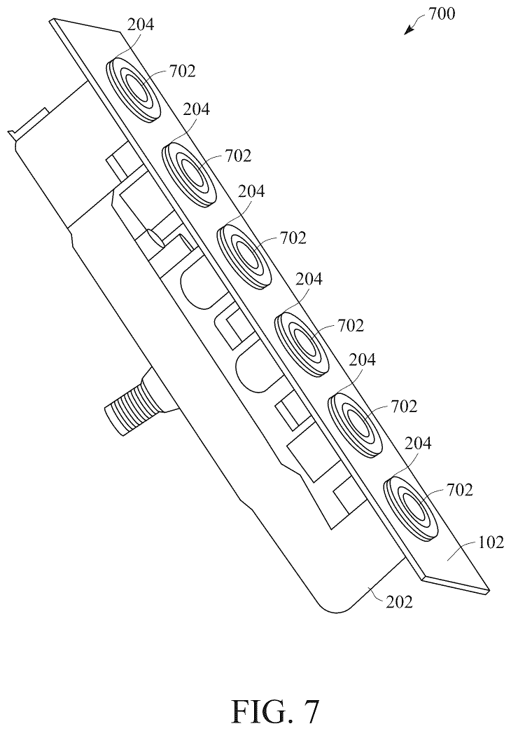

Referring now to FIG. 7 depicts a perspective view 700 of the multiplex switch panel assembly 202 with indicator lighting in accordance with an illustrative embodiment. FIG. 7 provides a detailed look at the front appearance of the multiplex switch panel assembly 202, emphasizing the integrated indicator lighting features.

In the perspective view 700, the multiplex switch panel assembly 202 is shown mounted on the panel 102 with a clear focus on the front side of the multiplex switch panel assembly 202. The plurality of anti-vandal pushbutton switches 204 may be prominently displayed, each equipped with integrated indicator lights 702 or backlights.

The indicator lights 702 within each anti-vandal pushbutton switch 204 may be visible and may be seen through translucent or transparent switch covers. These lights may be capable of displaying various colours and brightness levels, allowing for customizable visual feedback. FIG. 7 highlights how the indicator lighting enhances the usability of the anti-vandal pushbutton switch 204 by providing clear visual cues about its status or function.

The split mounting rings 302 may be visible around each anti-vandal pushbutton switch 204, securing the plurality of anti-vandal pushbutton switches 204 in place and contributing to the seamless appearance of the panel assembly on the front side. The multiplex switch panel assembly 202 may be designed to ensure that the indicator lights 702 are well-aligned and uniformly visible across all anti-vandal pushbutton switches 204, creating a cohesive and professional look.

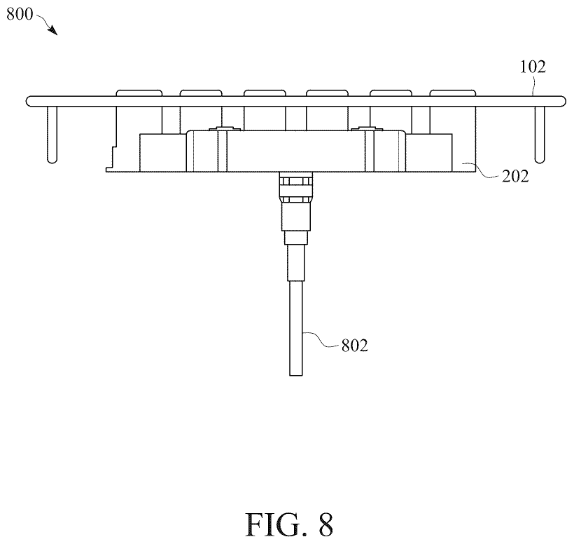

Referring now to FIG. 8 depicts a side view 800 of the multiplex switch panel assembly 202 integrated with a printed circuit board (PCB) that electrically connects to the plurality of anti-vandal pushbutton switches 204 in accordance with an illustrative embodiment. In the side view 800, the panel 102 is shown with the multiplex switch panel assembly 202 installed. The multiplex switch panel assembly 202 includes the plurality of anti-vandal pushbutton switches 204, which may be positioned through the corresponding hole 104 in the panel 102. The anti-vandal pushbutton switch 204 is illustrated as protruding through the front side of the panel 102.

The printed circuit board (PCB) (Not Shown) may be shown mounted on the rear side of the panel 102. The PCB may be connected to each of the plurality of anti-vandal pushbutton switches 204, consolidating the electrical connections and facilitating the operation of the anti-vandal pushbutton switch 204. The PCB may serve as the central hub for wiring, enabling digital communication, and supporting programmable functionalities such as switch behavior and indicator lighting. A cable 802 is electrically coupled to the PCB to power it and may facilitate data transmission. Cable 802 may be designed with a multi-conductor configuration, allowing for the distribution of power and communication signals between the PCB and external control units.

The figure highlights how the PCB may be positioned and connected to the anti-vandal pushbutton switch 204. The electrical connections between the PCB and the anti-vandal pushbutton switch 204 may be critical for the proper functioning of the multiplex switch panel assembly 202, including the control of indicator lights 702 or backlights within the anti-vandal pushbutton switch 204. Cable 802 further ensures that the necessary electrical power is delivered to the PCB.

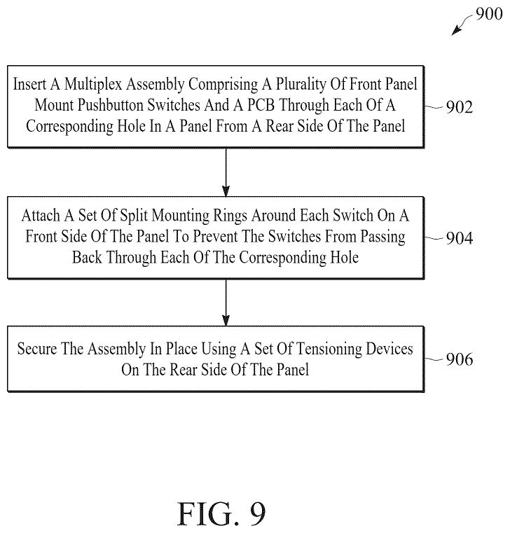

Referring now to FIG. 9 is a flowchart of a method 900 of installing the multiplex switch panel assembly 202 in accordance with an illustrative embodiment. This flowchart illustrates the sequential steps involved in the installation process of the multiplex switch panel assembly 202, highlighting each phase from preparation to final installation.

At step 902, insert the multiplex switch panel assembly 202, which includes the plurality of anti-vandal pushbutton switches 204 and the printed circuit board (PCB), through each corresponding hole 104 from the rear side of the panel 102, ensuring that the anti-vandal pushbutton switch 204 aligns correctly with its respective hole.

At step 904, once the anti-vandal pushbutton switch 204 may be positioned through the holes 104, attach a set of split mounting rings 302 around each anti-vandal pushbutton switch 204 on the front side of the panel 102. These rings prevent the switches from passing back through the holes 104, securing them in place.

At step 906, secure the multiplex switch panel assembly 202 in place by using a set of tensioning devices 206 on the rear side of the panel 102. The tensioning devices 206, which may include screws, springs, wedges, ramped rings, or shims, ensure that the assembly is firmly held and accommodates varying panel thicknesses.

In an embodiment of the present invention, for outdoor or marine applications, the switch panel assembly may incorporate a unique waterproofing method that does not require vent holes, unlike many conventional designs.

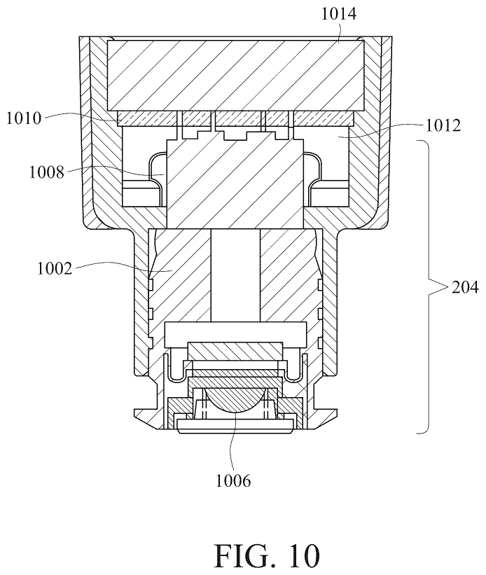

Referring now to FIG. 10, a cross-sectional view of a waterproof pushbutton switch assembly is shown. FIG. 10 illustrates the internal structure of one switch module within a multiplex switch panel assembly configured for environmental sealing while preserving tactile responsiveness.

The multiplex switch panel assembly 202 includes a housing 1002 that defines the outer protective enclosure for the switch system. The housing 1002 is molded from ASA or ASA-blend plastic, selected for its ultraviolet (UV) resistance, impact strength, and surface energy conducive to potting adhesion.

An anti-vandal pushbutton switch 204 is installed into the housing 1002, extending vertically from the lower portion. The anti-vandal pushbutton switch 204 includes an actuator cap 1006, a sleeve body 1008, and internal electromechanical switching elements. The actuator cap 1006 is designed to protrude through a corresponding hole in a front panel.

In an embodiment of the present invention, an O-ring is applied between the barrel of the anti-vandal pushbutton switch 204 and the housing 1002 to create a seal between each switch barrel and the housing on the front of the assembly. In some embodiments, a potting compound is applied to create the seal between each switch barrel and the housing.

Mounted above the anti-vandal pushbutton switch 204 and secured within the housing 1002 is a printed circuit board (PCB) 1010. The PCB 1010 is electrically connected to the anti-vandal pushbutton switch 204 and may interface with additional components such as RGB LEDs, microcontrollers, or communication buses.

Positioned below the PCB 1010 and above the sleeve body 1008 is an air cavity 1012. The air cavity 1012 is deliberately maintained as a shared volume among a plurality of switches within the multiplex assembly to ensure that the switch retains its tactile response even after the housing is sealed. The cavity volume is engineered to be at least several times greater than the air volume within an individual switch, based on empirical testing.

Above the PCB 1010, the interior region of the housing 1002 is filled with a potting compound 1014, such as a two-part urethane formulation. The potting compound 1014 provides environmental sealing, mechanical stabilization, and protection against moisture, dust, and vibration. The potting compound is selected with high viscosity (>10,000 cP) and short working time (<30 minutes) to prevent seepage past the PCB. Surface tension, combined with internal air pressure, helps maintain the boundary between the air cavity and the potting.

The PCB 1010 itself serves as a barrier that separates the potting compound 1014 from the air cavity 1012. The system relies on the viscosity of the potting material, the surface tension across the flat surface of the PCB 1010, and the internal pressure within the air cavity 1012 to prevent the potting compound 1014 from seeping past the board during curing.

This construction method enables the creation of a fully sealed switch assembly without any vent holes or mechanical seals around the switch or the PCB. It simplifies manufacturing and improves long-term reliability in marine, automotive, outdoor, and ruggedized environments.

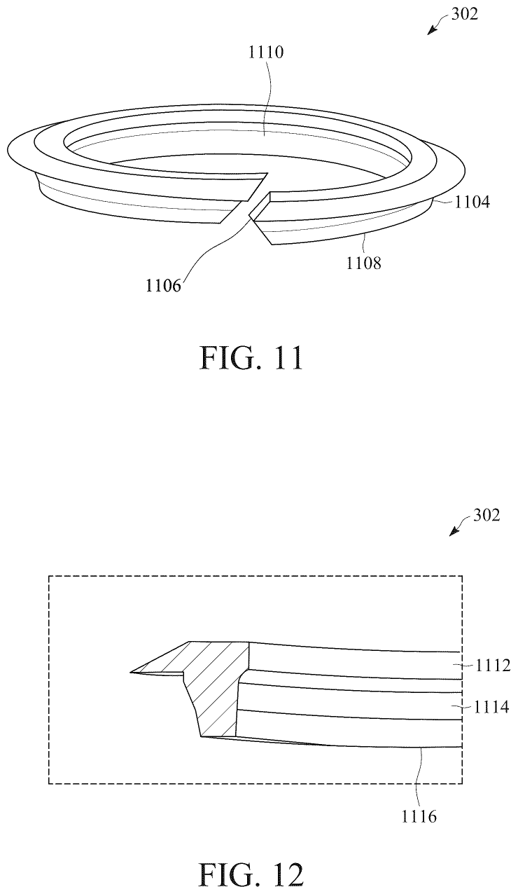

Referring now to FIG. 11, a perspective view of a split mounting ring 302 is shown. The split mounting ring 302 is configured to engage a front panel mount anti-vandal pushbutton switch 204, previously described from the front side of a panel 102, after the switch is inserted through a corresponding panel opening from the rear side.

The split mounting rings 302 feature a circumferential body 1104 that defines a generally cylindrical or annular profile sized to fit within or slightly over the periphery of a panel hole. An angled split 1106 is formed along the circumference of the ring, allowing it to flex inward or outward during installation. The angled split 1106 is angled relative to the ring's axis (i.e., not perpendicular), which enables the ring to compress more uniformly and minimizes the appearance of the gap once fully seated.

The split mounting rings 302 further include a helical twist or spiral contour along their circumferential axis, allowing for easier injection molding and improved alignment tolerance. This helical geometry ensures the split mounting rings 302 can be compressed into a slightly irregular or imperfect panel hole and still maintain a snug fit against the switch barrel.

In an embodiment, the inner diameter of the split ring is more than the outer diameter in the mating area of the switch barrel to allow for varying tolerance.

The outer surface 1108 of the ring may be beveled or contoured to assist insertion into the panel opening and to reduce the risk of binding or interference with the switch bezel. The inner surface 1110 may include a radial retention feature or shoulder that abuts the switch flange to prevent axial withdrawal.

The split mounting ring 302 is preferably molded from ASA or ASA-blend plastic, selected for its UV stability, mechanical strength, and flow properties suitable for producing complex molded parts like angled splits and spiral contours.

Referring now to FIG. 12, a side cross-sectional view of the split mounting ring 302 is illustrated, showing its interaction with a wall of the panel 102 and anti-vandal pushbutton switch 204.

The split mounting rings 302 include a flange 1112 that is slightly larger in diameter than the panel hole. The flange 1112 rests on the front surface of the panel 102 when the ring is installed, providing axial support and preventing the ring from being pushed back through the panel during use.

Beneath the flange 1112, the body of the split mounting rings 302 tapers inward along a frusto-conical or stepped profile 1114, allowing it to conform to various switch body diameters and panel tolerances. The profile 1114 may include compressible segments, snap tabs, or radial ribs that create a self-locking or spring-fit engagement with the panel and switch.

An inner retention surface 1116 of the ring interfaces with the switch barrel or collar and may apply radial preload when compressed by the tensioning device 206. This configuration ensures that the switch remains firmly seated against the ring and maintains consistent alignment across all switches in the panel.

The cross-section also illustrates how the angled split 1106 and helical twist distribute compression forces evenly around the ring circumference, even in the presence of minor irregularities in the panel or switch geometry.

The split ring design thus offers a self-centering, aesthetically consistent, and mechanically reliable retention solution for rear-mounted switches, enabling a clean front appearance without visible fasteners while accommodating manufacturing tolerances and thermal expansion.

In an embodiment of the invention, a customizable center cap assembly is provided for use with a front panel mounted anti-vandal pushbutton switch. The center cap includes a base body constructed from a light-transmissive material, such as a clear or translucent polymer. Suitable materials include polycarbonate or acrylic, which offer excellent optical clarity and mechanical durability.

An opaque coating or film is applied over the outer surface of the base body. This coating may be deposited using methods such as spraying, printing, or transfer lamination, and is selected for its contrast characteristics and visual aesthetic, with common colors including black, gray, or other neutral tones.

To enable illuminated indicators or legends, portions of the opaque layer are selectively removed through a laser engraving process. This process exposes the underlying translucent substrate, forming high-resolution graphical features such as icons, text, or symbols. These exposed regions act as optical windows, allowing light from internal illumination sources, such as RGB LEDs, to pass through and provide backlit indication. The method provides a robust and wear-resistant marking technique, eliminating the need for additional printed labels, film overlays, or adhesive inserts.

The center cap is further configured with at least two indexing features positioned circumferentially around the cap's underside. These features are angularly offset, typically by ninety degrees, and are dimensioned to engage with corresponding structural elements on the mating switch actuator or housing. As a result, the cap can be securely mounted in either of two predefined orientations, typically vertical and horizontal, relative to the surrounding control panel or device face.

This dual-orientation mounting configuration enables the use of a single part across differently oriented equipment layouts, thereby reducing inventory complexity and increasing installation flexibility. For example, a switch cap engraved with a directional arrow or function label can be rotated and installed in landscape or portrait panels without requiring different part numbers for each layout.

When fully assembled, the cap conforms to the profile of the underlying actuator, generally presenting a circular outer surface that integrates seamlessly with the switch housing. The cap may be affixed to the actuator using press-fit engagement, snap-fit geometry, or an adhesive interface, depending on the manufacturing or serviceability requirements. Once installed, the cap remains locked in its designated orientation due to the interaction of the indexing features with internal detents or slots in the switch body.

The design as described facilitates enhanced user feedback through illuminated, customizable legends while simultaneously improving mechanical alignment, installation accuracy, and field-level adaptability. The ability to offer configurable cap features in a standard modular housing supports streamlined production workflows and cost-effective deployment across varied control panel configurations.

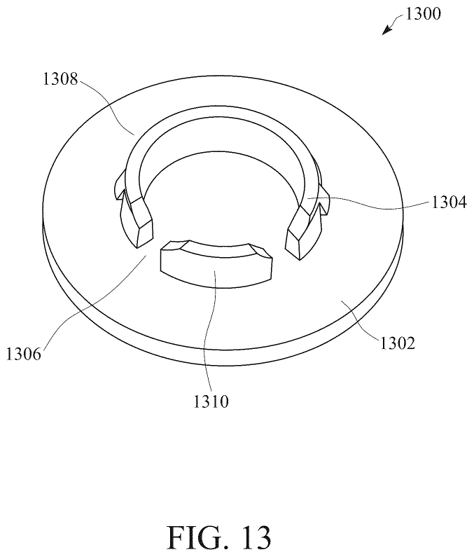

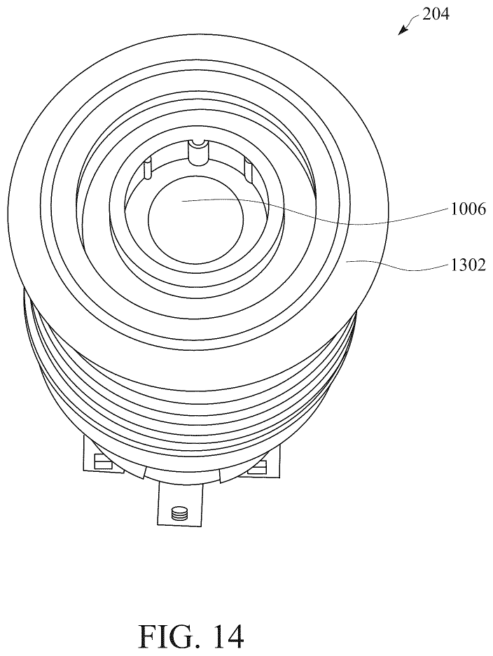

FIG. 13 illustrates a perspective view of a center cap 1300 configured for use with an anti-vandal pushbutton switch 204 of a multiplex switch panel assembly. The center cap 1300 comprises a substantially circular base plate 1302 with a raised inner ring 1304 formed concentrically along its upper surface. The inner ring 1304 includes an open section or split 1306 allowing for flexible engagement with the actuator shaft of a switch.

Disposed radially within the inner ring 1304 are a plurality of mechanical features that assist in retention and orientation. A single larger feature 1310 acts as an indexing notch, providing a unique alignment reference for orienting the center cap 1300 with respect to the switch assembly. Additionally, four equally spaced smaller features 1308 are arranged at 90-degree intervals around the inner ring 1304. These smaller features function as crush ribs, designed to provide frictional retention when the clip features of the center cap engage with the actuator shaft. The combination of the indexing notch 1310 and the symmetrically distributed crush ribs 1308 ensures both precise alignment and secure mechanical engagement, enabling reliable installation and consistent orientation in field applications. Referring now to FIG. 14, a top perspective view of the anti-vandal pushbutton switch 204 is shown with the center cap assembled over the actuator cap 1006. The base plate 1302 of the center cap is installed on the actuator, concealing the actuator cap 1006 beneath. The base plate 1302 is also referred to as the switch body and switch flange. This is the outer metal portion of the switch which does not allow light transmission. 1006 is the illuminator, which is a translucent plastic to allow light to transmit through it.

The base plate 1302 has a generally circular outer profile that conforms closely to the top surface of the actuator cap 1006. The center cap may be retained via a press-fit, snap-fit, or adhesive bonding depending on the selected assembly technique. As shown in FIG. 13 and visible through the translucent material in FIG. 14, the center cap includes a larger indexing feature (referenced as 1310 in FIG. 13) and a plurality of smaller crush ribs (e.g., 1308 in FIG. 13) spaced symmetrically along the inner ring. These internal engagement features align with corresponding structures within the actuator cap, ensuring the center cap is mounted in the correct orientation and resists unintended rotation during operation.

The present invention provides several significant advantages over conventional switch panel assemblies are ensuring a clean and seamless front appearance on the panel, replicating the look of individually installed front panel mount switches without the gaps typically associated with rear mounting. This aesthetic is achieved through the use of split mounting rings and precise installation techniques. The method of rear mounting the assembly, combined with the use of split mounting rings and tensioning devices, streamlines the installation process. This approach reduces the time and effort required to install multiple switches individually and minimizes the need for adjustments after installation.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits, and advantages. These also include embodiments in which the components and/or steps are arranged and/or ordered differently.

While the foregoing drawings have been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study, except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

What is claimed is:

1. A switch panel assembly configured for rear panel mounting, comprising:
a panel having a front side and a rear side;
a plurality of anti-vandal pushbutton switches, each configured to extend through a corresponding hole in the panel from the rear side to the front side;
a plurality of split mounting rings, each configured to be positioned around a respective anti-vandal pushbutton switch on the front side of the panel to prevent an anti-vandal pushbutton switch from passing back through the corresponding hole; and
a tensioning mechanism disposed on the rear side of the panel, the tensioning mechanism being configured to apply axial pressure to the anti-vandal pushbutton switches, thereby compressing the split mounting rings against the front side of the panel and securing the anti-vandal pushbutton switches in position.

2. The switch panel assembly of claim 1, wherein the tensioning mechanism comprises one or more of: screws, springs, wedges, ramped rings, or shims.

3. The switch panel assembly of claim 1, wherein each of the split mounting rings has a helical shape and an angled split, configured to reduce visible gaps and enable compression during mounting.

4. The switch panel assembly of claim 1, wherein the split mounting rings are dimensioned to accommodate variations in size and shape among the plurality of anti-vandal pushbutton switches.

5. The switch panel assembly of claim 1, further comprising indicator lights integrated into each pushbutton switch, wherein lighting features are programmable.

6. The switch panel assembly of claim 5, wherein the indicator lights are RGB LEDs, and each of the indicator lights includes independent brightness control for each color channel to allow visual customization.

7. The switch panel assembly of claim 1, further comprising a printed circuit board (PCB) positioned behind the anti-vandal pushbutton switches, wherein the PCB is electrically connected to each switch.

8. The switch panel assembly of claim 7, wherein the PCB is configured to communicate via a connector that provides both power and digital communication signals.

9. The switch panel assembly of claim 7, wherein each pushbutton switch comprises integrated RGB lighting, and the PCB is configured to independently control brightness and color output of each of the plurality of anti-vandal pushbutton switches.

10. The switch panel assembly of claim 7, wherein the PCB is programmed to facilitate digital communication for controlling switch functions and lighting behaviors.

11. A switch panel assembly comprising:
a housing;
a plurality of anti-vandal pushbutton switches sealed within the housing;
a printed circuit board (PCB) mounted within the housing and electrically connected to the pushbutton switches;
an internal air cavity disposed between the plurality of anti-vandal pushbutton switches and the PCB; and
a potting compound disposed on a side of the PCB opposite the internal air cavity, wherein the PCB acts as a barrier to prevent ingress of the potting compound into the internal air cavity.

12. The switch panel assembly of claim 11, wherein the potting compound has a viscosity of at least 10,000 centipoise and a working time of less than 30 minutes.

13. The switch panel assembly of claim 11, wherein the potting compound comprises a two-part urethane formulation.

14. A switch panel assembly configured for rear panel mounting, comprising:
a panel having a front side and a rear side;
a plurality of anti-vandal pushbutton switches, each configured to extend through a corresponding hole in the panel from the rear side to the front side; and
a plurality of split mounting rings, each comprising:
a circumferential body having a helical contour along its axis;
an angled split defined between opposing ends of the circumferential body; and
a front flange configured to rest against the front side of the panel to resist rearward movement of the respective anti-vandal pushbutton switch.

15. The switch panel assembly of claim 14, wherein each of the plurality of split mounting rings is formed of ASA or an ASA-blend plastic.

16. The switch panel assembly of claim 14, wherein a cross-sectional profile of the circumferential body of the split mounting ring is tapered or stepped to accommodate tolerance variations between the pushbutton switch and the panel opening.

17. The switch panel assembly of claim 14, further comprising a center cap for at least one of the anti-vandal pushbutton switches, the center cap comprising:
a base layer, the base layer is transparent or translucent;
an opaque coating disposed on a front face of the base layer;
a selectively removed portion of the opaque coating forming a text or symbol by laser engraving; and
two indexing features disposed 90 degrees apart on the center cap, the indexing features being configured to engage corresponding features on the pushbutton switch to permit either vertical or horizontal installation.

18. The switch panel assembly of claim 17, wherein the base layer of the center cap is formed from polycarbonate or acrylic.
